(19) United States
(12) Patent Application Publication
(10) Pub. No.: US 2014/0243144 A1
(43) Pub. Date: Aug. 28, 2014

(54) PLANETARY PINION SHAFT

(71) Applicant: SCHAEFFLER TECHNOLOGIES GMBH & CO. KG, Herzogenaurach (DE)

(72) Inventors: Shawn PIERCE, Fort Mill, SC (US); Charles M. SCHWAB, Fort Mill, SC (US)

(73) Assignee: SCHAEFFLER TECHNOLOGIES GMBH & CO. KG, Herzogenaurach (DE)

(21) Appl. No.: 14/189,525

(22) Filed: Feb. 25, 2014

Related U.S. Application Data
(60) Provisional application No. 61/770,095, filed on Feb. 27, 2013.

(51) Int. Cl. F16H 57/08

(52) U.S. Cl. CPC F16H 57/08
USPC 475/331

(57) ABSTRACT

A planetary drive including a planet carrier with two axially spaced supports that include aligned bores is provided. A planetary gear is located on a through hardened pinion shaft extending axially through the aligned bores. The pinion shaft includes locally deformed axial ends such that the pinion shaft is axially fixed within the planet carrier and is circumferentially rotatable.

### INCORPORATION BY REFERENCE

The following documents are incorporated herein by reference as if fully set forth: U.S. Provisional Application No. 61/770,095, filed Feb. 27, 2013.

### FIELD OF INVENTION

This application is generally related to a planetary gear drive and more particularly related to a planetary pinion shaft.

### BACKGROUND

Planetary gear drives are widely used in various mechanical applications, including automotive and industrial applications, especially automatic transmissions and transfer cases. Types of planetary gearsets include simple, compound, Ravigneaux-type, and planetary differentials. Typically, planetary pinion shafts have non-hardened ends and are fixed into a mating planetary gearset carrier via a staking operation or with a mechanical device, such as a retaining ring or dowel pin. Known planetary pinion shafts are disclosed in U.S. Pat. No. 5,356,352 and U.S. Pat. No. 7,276,012.

Planetary pinion shafts typically require localized heat treatment such that the middle of the shaft that includes a bearing contact surface for the planetary gear or planetary gear bearing is hardened but the ends of shaft are soft. This heat treatment process increases manufacturing costs. The soft ends of the shaft are then staked into the carrier. Such pinion shafts also have hollow end portions to allow the shaft ends to be deformed for staking. After staking, the pinion shaft is axially fixed and is also prevented from circumferential rotation. Due to this fixed arrangement, the load contact zone of the pinion shaft is concentrated to a specific circumferential area on the pinion shaft. This stress concentration results in spalling and shortens the life of the pinion shaft. Existing through hardened pinion shafts are used in conjunction with secondary mechanical retention devices, e.g. retaining rings or dowel pins. However, these retention devices negate the cost benefit of using a through hardened pinion shaft.

It would be desirable to both vary the contact area of a pinion shaft and reduce the manufacturing costs associated with producing the pinion shaft.

### SUMMARY

It would be desirable to provide a pinion shaft that is circumferentially rotatable such that the load contact zone is varied around the pinion shaft, and that also simplifies the heat treatment process, the end geometry of the pinion shaft, and the mounting of the pinion shaft.

A planetary drive including a planet carrier with two axially spaced supports that include aligned bores is provided. A planetary gear rotates on a through hardened pinion shaft extending axially through the aligned bores. The pinion shaft includes locally deformed axial ends such that the pinion shaft is axially fixed within the planet carrier and is circumferentially rotatable.

A method of fixing a pinion shaft within a planetary drive is also provided. The pinion shaft comprises a through hardened shaft blank. The method comprises positioning the pinion shaft in aligned bores of two axially spaced supports of the planet carrier and through the planetary gear. An impact force is applied to axial ends of the pinion shaft such that the axial ends of the pinion shaft are locally deformed and the pinion shaft is axially fixed within the planet carrier and is circumferentially rotatable.

Preferred arrangements with one or more features of the invention are described below and in the claims.

### BRIEF DESCRIPTION OF THE DRAWINGS

The foregoing Summary as well as the following Detailed Description will be best understood when read in conjunction with the appended drawings. In the drawings:

FIG. 1 is a partial, cross-sectional view of a planetary drive according to the invention.

FIG. 2 is side view of a pinion shaft.

FIG. 3 is a partial, cross-sectional view of the pinion shaft prior to deformation of the axial ends.

FIG. 4 shows the die immediately prior to deforming the axial ends of the pinion shaft.

FIG. 5 is a magnified view of an axial end of the pinion shaft after deformation.

### DETAILED DESCRIPTION OF THE PREFERRED EMBODIMENTS

Certain terminology is used in the following description for convenience only and is not limiting. The words “inner,” “outer,” “inwardly,” and “outwardly” refer to directions towards and away from the parts referenced in the drawings. A reference to a list of items that are cited as “at least one of a, b, or c” (where a, b, and c represent the items being listed) means any single one of the items a, b, c or combinations thereof. The terminology includes the words specifically noted above, derivates thereof, and words of similar import.

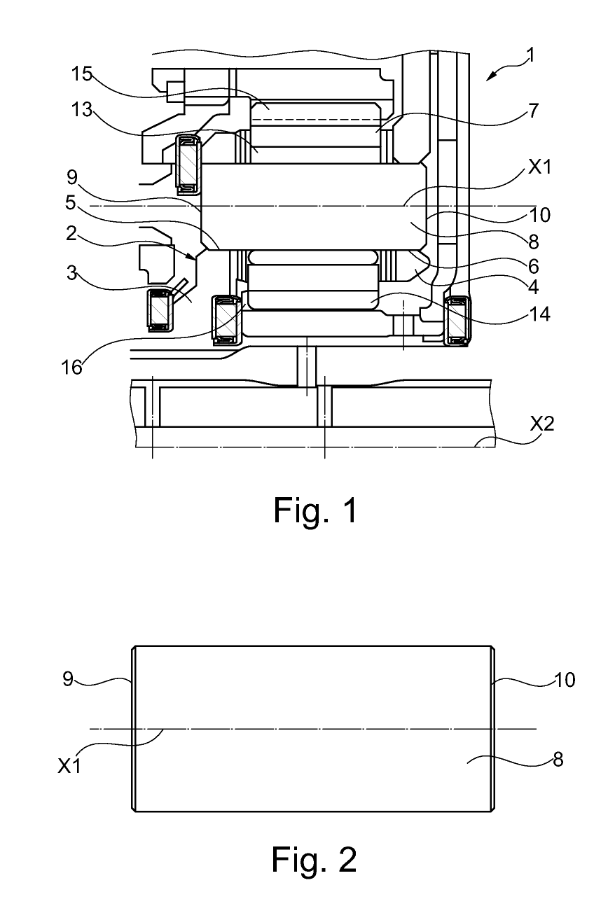

FIG. 1 shows a preferred embodiment of the planetary drive 1 according to the present invention. In the example embodiment shown, the planetary drive 1 includes a planet carrier 2 including two axially spaced supports 3, 4 that include aligned bores 5, 6. One of the planetary gears 7 is shown located on a through hardened pinion shaft 8 extending axially through the aligned bores 5, 6. A needle roller bearing assembly 13 is provided between the pinion shaft 8 and the planetary gear 7, which act as inner and outer races. Alternatively a plain bearing can be found between the pinion shaft 8 and the gear 7. The pinion shaft 8 rotates about a rotation axis X1 that is parallel to a rotation axis X2 of the planet carrier 2. The pinion shaft 8 is formed from steel that is preferably through hardened to a Rockwell hardness between 58-64. The pinion shaft 8 is fully heat treated and tempered and is preferably SAE 52100 steel. The planetary gear 7 includes teeth 14 that mate with corresponding ring gear teeth 15 and sun gear teeth 16.

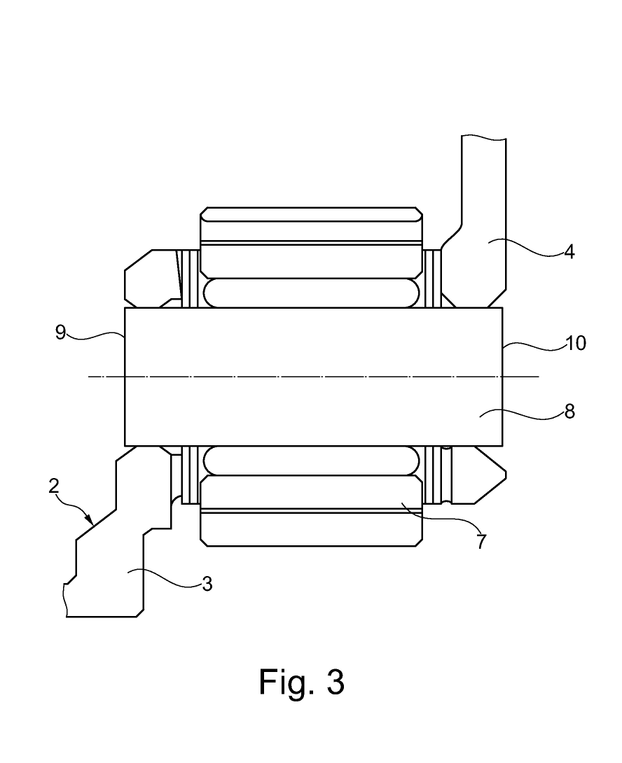

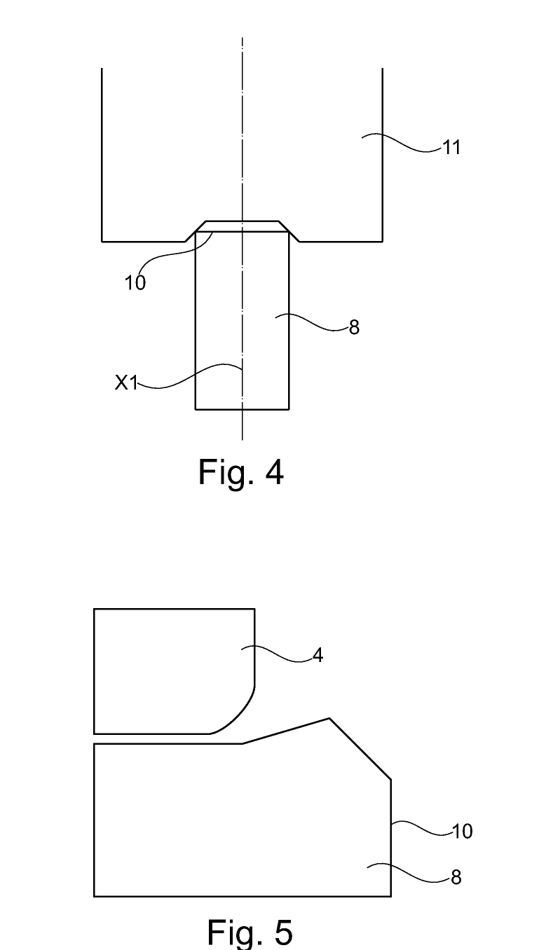

FIG. 3 shows the assembly prior to locally deforming the axial ends 9, 10 of the pinion shaft 8. By way of example, FIG. 4 shows the axial end 10 of the pinion shaft 8 immediately prior to undergoing deformation. The locally deformed axial ends 9, 10 are formed by opposing dies 11, 12 that apply an impact force to each end 9, 10 at the same time. The dies 11, 12 each include a recess with an angled surface or surfaces arranged to contact a circumferential edge of the axial ends 9, 10 of the pinion shaft 8. The locally deformed axial ends 9, 10 axially fix the pinion shaft 8 within the planet carrier 2. The pinion shaft 8 remains circumferentially rotatable about its axis X1 in the planet carrier 2. FIG. 5 shows an axial clearance is provided between each of the locally deformed axial end 9, 10 of the pinion shaft 8 and a respective one of the supports 3, 4 of the planet carrier 2. Accordingly, the load zone on the pinion shaft 8 that bears the forces from the planetary gear 7 varies since the pinion shaft 8 rotates.

Having thus described various embodiments of the present planetary drive in detail, it is to be appreciated and will be apparent to those skilled in the art that many changes, only a few of which are exemplified in the detailed description above, could be made in the apparatus without altering the inventive concepts and principles embodied therein. The present embodiments are therefore to be considered in all respects as illustrative and not restrictive, the scope of the invention being indicated by the appended claims rather than by the foregoing description, and all changes which come within the meaning and range of equivalency of the claims are therefore to be embraced therein.

### LOG TO REFERENCE NUMBERS

1 Planetary Drive

2 Planet Carrier

3, 4 Supports

5, 6 Bores

7 Planetary Gear

8 Pinion Shaft

9, 10 Ends

11, 12 Dies

13 Needle Roller Bearing Assembly

14 Planetary Gear Teeth

15 Ring Gear Teeth

16 Sun Gear Teeth

X1 Rotation Axis of Pinion Shaft

X2 Rotation Axis of Planetary Carrier

What is claimed is:

1. A planetary drive, comprising:
a planet carrier including two axially spaced supports that include aligned bores, and
a planetary gear located on a through hardened pinion shaft extending axially through the aligned bores and including locally deformed axial ends such that the pinion shaft is axially fixed within the planet carrier and is circumferentially rotatable.

2. The planetary drive of claim 1, wherein the pinion shaft has a Rockwell hardness between 58-64.

3. The planetary drive of claim 1, wherein an axial clearance is provided between each of the locally deformed axial ends and a respective one of the supports.

4. The planetary drive of claim 1, wherein a needle roller bearing assembly is provided between the planetary gear and the pinion shaft.

5. A method of fixing a pinion shaft within a planetary drive, said pinion shaft comprising a through hardened shaft blank, the method comprising:
arranging a planetary gear in a planet carrier,
positioning the pinion shaft in aligned bores of two axially spaced supports of the planet carrier and through the planetary gear, and
applying an impact force to axial ends of the pinion shaft such that the axial ends of the pinion shaft are locally deformed and the pinion shaft is axially fixed within the planet carrier and is circumferentially rotatable.

6. The method of claim 5, further comprising:
locating a needle roller assembly between the planetary gear and the pinion shaft.
